(19) United States
(12) Patent Application Publication
(10) Pub. No.: US 2002/0096061 A1
(43) Pub. Date: Jul. 25, 2002

(54) Apparatus for depackaging and recovering viscous products

(76) Inventor: Jeffrey A. Swiatlo, Bartlett, IL (US)

Correspondence Address: ROBERT F. VAN EPPS, ATTORNEY AT LAW, 192 NORTH YORK ROAD, ELMHURST, IL, 60126, US

(21) Appl. No.: 09/764,038

(22) Filed: Jan. 19, 2001

(51) Int. Cl. B30B 9/06

(52) U.S. Cl. 100/110; 100/117

(57) ABSTRACT

A machine for depackaging viscous or flowable products, wherein a continuous feed mechanism conveys packaged product against converging perforated press plates causing the product package to rupture under pressure. The ruptured packaging is further compressed forcing the product through the perforated plates for collection in a holding tank. The compressed packaging material is forced between the press plates with minimal product retention for recycling or disposal. The distance between the press plates at their closes conversion is adjustable by means of pneumatic cylinders to accommodate various types of packaging and product materials.

### BACKGROUND OF THE INVENTION

1. Field of the Invention

The present invention relates generally to methods and apparatus for depackaging products and more particularly to an apparatus for depackaging products having viscous or flowable properties.

2. Description of the Prior Art

There are many products, particularly in the food industry, which require removal from the in stream of commerce. Examples include products which may be defectively labeled during the production process or returned because of having become out-dated prior to sale. Among these products are included such materials as cottage cheese, tomato paste and condiments all of which are to one degree or another viscous, but do not flow freely upon opening their containers.

In order to recover the product for reprocessing or disposal, it is necessary to remove it from its package. Prior to the present invention, a machine for extracting flowable food from crushable containers was described in U.S. Pat. No. 4,852,817 which issued to Walter E. Tipton on Aug. 1, 1989. The Tipton apparatus employs an inclined auger in a barrel having angularly spaced internal ribs. As the product is driven upwardly by the auger, the container is torn open by the ribs and the liquid product then flows downwardly by gravity to a collection tank. The grinding and tearing of the packaging tends to result in contamination of the recovered product with particles of packaging material. While this may be acceptable when product is being recovered for use in agricultural feed, it limits the capacity of the machine to recover the product for reprocessing. In the use of the Tipton apparatus to recover products which are not readily flowable, the resistance of the product to flow down the barrel requires the introduction of a diluting fluid, e.g. water, which tends to prevent product recovery for reprocessing rather than disposal.

### OBJECTIVES AND SUMMARY OF THE INVENTION

From the preceding discussion, it will be understood that among the various objectives of the present invention are included the following:

The provision of a new and improved apparatus for depackaging products;

The provision of an apparatus of the above-described character with an improved capacity to depackage viscous products; and

The provision of an apparatus of the above-described character which minimizes contamination of the recovered product with packaging material.

These and other objectives of the present invention are efficiently achieved by providing an auger drive for accepting the packaged product at one end and transporting the same axially to a product extraction chamber. The product extraction chamber is provided with opposed converging perforated press plates. As the product is delivered against the press plates, the packaging is caused to rupture under the pressure. The product is released and forced through the perforated press plates for collection in a tank. The compressed packaging material is forced between the converging press plates to an exhaust chute for collection and recycling or disposal.

The foregoing, as well as other objects, features and advantages of the present invention, will become more apparent from the following detailed description taken in conjunction with the various views of the appended drawings.

### BRIEF DESCRIPTION OF THE DRAWINGS

FIG. 1. is a side view of the apparatus of the present invention with internal elements shown in phantom;

FIG. 2. is a top view of the apparatus of FIG. 1.

FIG. 3. is a partial perspective view of the product extraction portion of the apparatus of FIGS. 1 and 2.

### DESCRIPTION OF PREFERRED EMBODIMENT

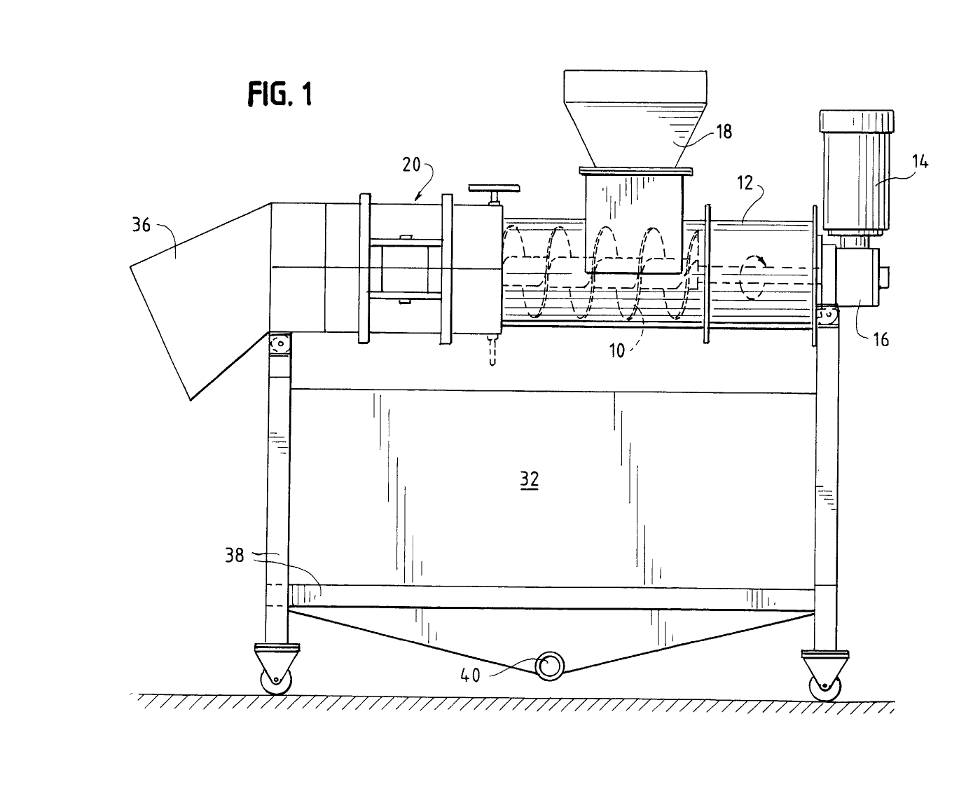

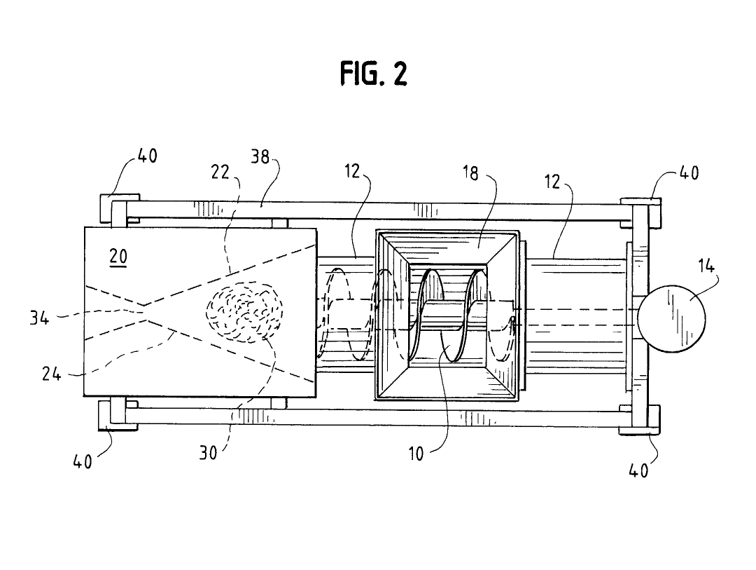

With reference now to FIGS. 1 and 2, wherein like elements are identified by like reference characters, there is illustrated a preferred embodiment of the present invention.

An auger 10, disposed coaxially within a tubular conveyor 12, is driven in rotation by a common electric motor 14 through a gear train 16 selected to provide a drive torque consistent with the particular size of the machine. An infeed chute 18 is provided for delivering packaged product to the auger 10.

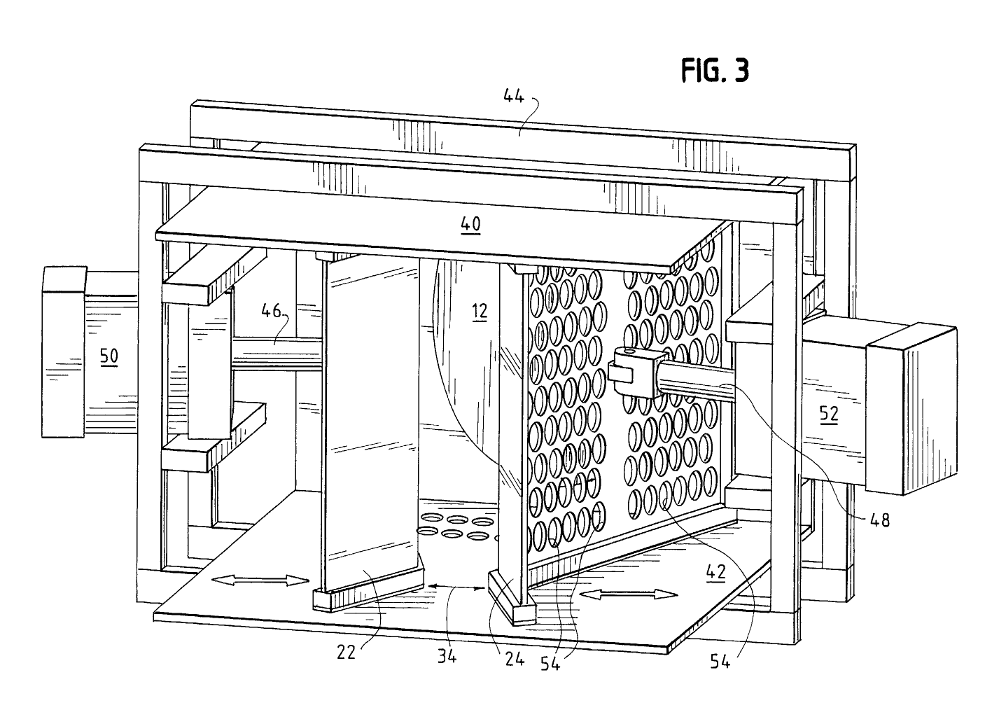

The packaged product is thus conveyed axially by the auger 10 to a product extraction chamber 20 having two opposed, converging, perforated press plates 22 and 24. The press plates are positioned by first and second pneumatic cylinders (see FIG. 3). As the packaged product is driven against the press plates 22 and 24, the pressure rises until the product package ruptures releasing the product into the extraction chamber 20. As the product package is compressed and the product is squeezed from the package, it is forced through the perforations in the press plates 22 and 24, as well as a perforated area 30 in the floor of the extraction chamber 20 and collected in a tank 32 located beneath.

The neck area 34 defined by the press plates 22 and 24, at their closest convergence, forms an outlet for the compressed container materials through an outlet chute 36 to a collection container (not shown) for recycling or disposal. The size of the neck area 34 is adjustable to accommodate varying container sizes in their compressed state.

FIG. 3. illustrates in greater detail the extraction chamber 20 of the present invention. Top and bottom plates, 40 and 42 respectively, are mounted in a rectangular framework 44 which is in turn adapted for mounting to the supporting framework 38 of FIGS. 1 and 2. The first and second opposed, converging, perforated press plates 22 and 24 are coupled via actuating arms 46 and 48 to respective pneumatic actuators 50 and 52. The plates 22 and 24 are thereby laterally adjustable to accommodate various sizes and styles of product containers.

As the packaged product is driven from the conveyor 12 against the opposed plates 22 and 24, the package ruptures under pressure and the product is forced through the perforations 54 and overflows the sides of the bottom plate 42 into the collection tank 32 of FIG. 1. The bottom plate 42 may, but need not necessarily, also be perforated at 56 such as to enhance product flow from the product extraction chamber. The compressed and substantially emptied containers are forced through the neck area 34 between the plates 22 and 24 for collection.

The depackaging apparatus is typically mounted in a supporting framework 38 on casters 40 for easy relocation. A product tank 32 could be either a separate unit rolled beneath the apparatus, or mounted to the framework 38 and provided with a drain cock 40.

Since the product package is ruptured under pressure rather than mechanically torn apart, as in the prior art, the applicant's apparatus produces a much lower contamination of the recovered product. This in turn allows the apparatus of the present invention to be useful in product recovery for reprocessing in cases where the product is useful and only the packaging or labeling may be defective.

From the foregoing, it will be understood that the applicant has provided a new and improved apparatus for depackaging and recovering products of a viscous or flowable character, wherein the objectives set forth hereinabove are efficiently achieved. Since certain changes in the above-described construction will occur to those skilled in the art, without departure from the scope of the invention, it is intended that all matter set forth in the above description or shown in the appended drawings shall be interpreted as illustrative and not in a limiting sense.

Having described what is new and novel and desired to secure by Letters Patent, what is claimed is:

1. An apparatus for separating a flowable product from a rupturable container comprising
first and second opposed converging perforated press plates disposed within a product extraction chamber;
means for driving containers of product against said press plates under sufficient pressure to cause said containers to rupture, thereby releasing said product to flow through the perforations in said press plates and forcing the ruptured container between said press plates; and
means for collecting said product flowing through said perforated press plates.

2. An apparatus as recited in claim 1 wherein said driving means comprises
a tubular conveyor in communication at one end with a product infeed chute and at the opposite end with said product extraction chamber;
an auger disposed coaxially within said tubular conveyor; and
means for driving said auger in rotation at a preselected torque.

3. An apparatus as recited in claim 1 wherein
the distance between said press plates at their closest convergence is sufficient to allow passage of said ruptured containers from said product extraction chamber.

4. An apparatus as recited in claim 3 further including
first and second pneumatic actuators, one coupled to each of said first and second press plates, for adjusting the distance between said press plates at their closest convergence.

5. An apparatus as recited in claim 1 wherein
the bottom of said product extraction chamber is perforated to thereby allow said product to flow therethrough to said product collection means.
